(19) United States
(12) Patent Application Publication
(10) Pub. No.: US 2025/0061313 A1
(43) Pub. Date: Feb. 20, 2025

(54) Flexible Classes for Statically Compiled Classification Graphs

(71) Applicant: SambaNova Systems, Inc., Palo Alto, CA (US)

(72) Inventors: Jonathan Li, Palo Alto, CA (US); Urmish Thakker, Leander, TX (US); Changran Hu, Sunnyvale, CA (US); Varun Talwar, Sunnyvale, CA (US); Bo Li, Foster City, CA (US); Venkat Krishna SRINIVASAN, Austin, TX (US); Amol Sharma, Redwood City, CA (US); Dong Hui Kim, Dublin, CA (US)

(73) Assignee: SambaNova Systems, Inc., Palo Alto, CA (US)

(21) Appl. No.: 18/234,358

(22) Filed: Aug. 15, 2023

(51) Int. Cl. G06N 3/048; G06N 3/047

(52) U.S. Cl. CPC G06N 3/048; G06N 3/047

(57) ABSTRACT

A system includes one or more processors and a statically reconfigurable dataflow processor (SRDAP) coupled to the processors which are programmed to receive a first request to generate an instantiation of a computation graph to generate a probability distribution for N classes and retrieve a compiled graph of the computation graph. The computation graph includes a bias node and a probability distribution node for M classes. The bias node provides a biased tensor of size M to the probability distribution node by adding a bias tensor. The processors generate a bias tensor having N entries equal to zero and M−N entries having negative values and then load the compiled graph with the first bias tensor into a first set coarse-grained reconfigurable units of the SRDAP. Execution of the computation graph is initiated on the SRDAP to generate the probability distribution and a first inference is provided.

### CROSS-REFERENCES AND INCORPORATIONS

The following are incorporated by reference for all purposes:
Prabhakar et al., “Plasticine: A Reconfigurable Architecture for Parallel Patterns,” ISCA '17, Jun. 24-28, 2017, Toronto, ON, Canada; and
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018.

### BACKGROUND

### Technical Field

The technology disclosed relates to using neural networks for classification in a statically reconfigurable dataflow architecture processor (SRDAP). In particular, it relates to using a computation graph pre-compiled to run on the SRDAP to classify data into a specific number of classes of data where the specific number of classes of data was not known at compile time.

### Context

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Neural networks are not commonly used to classify data. The neural network is trained using a corpus of training data and the trained neural network is then used to classify new inputs into one of a number of classes. Many different types of neural networks can be used to classify data, including fully connected multilayer perceptron networks (MLP), recurrent neural networks (RNN), long short term memory neural networks (L, and transformer neural networks.

Coarse grain reconfigurable architectures (CGRAs) which may be used for a statically reconfigurable dataflow architecture processors (SRDAPs) exhibit far superior performance over conventional architectures, such as field programmable gate arrays (FPGAs) to execute computation graphs representing neural networks as they provide the capability to execute applications as nested dataflow pipelines. Maximizing the utilization of compute units in the CGRA to perform useful computations is critical to harness the benefits of a CGRA. Compilation of a computation graph for a CGRA SRDAP may be computationally expensive as it includes not only the generation of configuration file for each coarse grained reconfigurable (CGR) unit, but the assignment of tasks to specific CGR units of a SRDAP and routing of data between the CGR units using the available data communication resources of the SRDAP.

### BRIEF DESCRIPTION OF THE DRAWINGS

The technology will be described with reference to the drawings, in which:

FIG. 1A shows a multilayer perceptron neural network suitable as a shared backbone for an implementation of a classification computation graph.

FIG. 1B shows a transformer neural network suitable as a shared backbone for an implementation of a classification computation graph.

FIG. 1C shows three implementations of classification computation graphs using a shared backbone.

FIG. 2 shows an implementation of a classification computation graph with an added bias node suitable for multiple classification tasks with different numbers of classes.

FIG. 3 shows three implementations of classification computation graphs using a common compiled graph.

FIG. 4 is a flowchart for an implementation of a method to generate a common compiled graph suitable for multiple classification tasks with different numbers of classes.

FIG. 5 is a flowchart for an implementation of a method to use a common compiled graph to classify a specific number of classes.

FIG. 6 illustrates an example system including a coarse-grained reconfigurable (CGR) processor, a host, and a memory.

FIG. 7 illustrates an example of a computer, including an input device, a processor, a storage device, and an output device.

FIG. 8 illustrates example details of a CGR architecture including a top-level network (TLN) and two CGR arrays.

FIG. 9 illustrates an example CGR array, including an array of CGR units in an array-level network (ALN).

FIG. 10 illustrates an example of a pattern memory unit (PMU) and a pattern compute unit (PCU), which may be combined in a fused-control memory unit (FCMU).

FIG. 11 is a block diagram of a compiler stack implementation suitable for generating a configuration file for a SRDAP.

FIG. 12 shows an example user program in an example first stage of the compiler stack.

FIG. 13 shows the user program in an example second stage of the compiler stack.

FIG. 14 shows the user program in an example third stage of the compiler stack.

FIG. 15 shows the user program in an example fourth stage of the compiler stack.

FIG. 16 shows the logical computation graph and an example physical layout of the user program.

In the figures, like reference numbers may indicate functionally similar elements. The systems and methods illustrated in the figures, and described in the Detailed Description below, may be arranged and designed in a wide variety of different implementations. Neither the figures nor the Detailed Description are intended to limit the scope of the claims. Instead, they merely represent examples of different implementations of the disclosed technology.

### DETAILED DESCRIPTION

Traditional compilers translate human-readable computer source code into machine code that can be executed on a Von Neumann computer architecture. In this architecture, a processor serially executes instructions in one or more threads of software code. The architecture is static, and the compiler does not determine how execution of the instructions is pipelined, or which processor or memory takes care of which thread. Thread execution is asynchronous, and safe exchange of data between parallel threads is not supported.

High-level programs for machine learning (ML) and artificial intelligence (AI) may require massively parallel computations, where many parallel and interdependent threads (metapipelines) exchange data. Such programs are ill-suited for execution on Von Neumann computers. They require architectures that are optimized for parallel processing, such as coarse-grained reconfigurable (CGR) architectures (CGRAs) which may be used in a statically reconfigurable dataflow architecture processor (SRDAP) or graphic processing units (GPUs). The ascent of ML, AI, and massively parallel architectures places new requirements on compilers, including how computation graphs, and in particular dataflow graphs, are pipelined, which operations are assigned to which compute units, how data is routed between various compute units and memory, and how synchronization is controlled particularly when a dataflow graph includes one or more nested loops, whose execution time varies dependent on the data being processed.

In some paradigms of machine learning, a model backbone, such as a classification neural network, may be defined for classifying input data into a large number of classes. This model backbone may be pretrained using a large corpus of data to allow the model backbone to be able to recognize a wide range of inputs, but it may not be fine-tuned for a specific task. Once the model backbone has been pretrained, a task-specific classification head for a particular number of classes required by the task may be added to the output of the shared backbone in the computation graph and recompiled. The compiled task-specific computation graph can then be finetune trained with additional training data targeted for the specific task to generate updated weights for the computation graph. The updated weights can then be used with the compiled task-specific computation graph can then be used to classify input data for the specific task more accurately than the model backbone could do on its own. But the weights generated during the pretraining using a large corpus of training data can provide a strong basis for the finetune training o the specific task need not bear the cost of the pretraining on its own as the pretrained weights can be useful for many different specific tasks within the broad context of the pretraining data.

For example, a model backbone may be trained to classify images that may show a wide range of subjects, such as animals, cars, airplanes, and more. A large number of images showing various animals, such as dogs, cats, and horses, various automobiles such as models from Chevrolet®, Buick®, and Toyota®, and various airplanes, such as a Boeing® 747, an F-16, and a Piper Cub®, among images of other things, can be provided to the model backbone as pretraining data and weights for the classification neural network can be generated during the pre-training. The pretraining can be time consuming and computationally expensive as the corpus of pretraining data may be very large. The number of classes that can be specified by the model backbone may be very large as well, and may include thousands of classes or more.

After the pretraining, the model backbone initialized with the weights generated during the pretraining may be useful to classifying the content of new images presented to the model backbone, but it may not be as capable as one would like for more specific tasks. For example, the trained model may be very good at differentiating a dog from it large number of other objects but may not be as successful at identifying a particular breed for the dog as may be needed for an application that will only provide images of dogs with the intent of determining its breed.

For the breed identification task, a classification head with 276 classes, one for each dog breed recognized by the American Kennel Club, may be created and added to the model backbone to replace the pretrain head in a computation graph specific to identifying dog breeds. The newly formed model is then compiled. The compiled computation graph can then be finetune trained with finetune training data showing multiple images of each breed of dog to update the weights in the computation graph. The compiled computation graph with the updated weights can then be used to classify images of dogs by the specific breed of the dog.

Similarly, another task might be to identify the model and year for Chevrolet automobiles, which may be limited to several hundred different model and ear combinations. The same pretrained backbone model may be mated with a classification head for the Chevrolet mode/year and recompiled. The newly compiled computation mode can then be finetuned with images specifically of Chevrolet automobiles to update the weights and then used to identify model and year of images of Chevrolet automobiles.

While the pretrain/finetune paradigm allows the very expensive pretraining to be amortized over many different task, each new task requires that a classification head be generated for each new task and the updated computation graph with the model backbone and the classification head to be recompiled. Compiling a computation graph for some architectures, such as a SRDAP using a CGRA, compiling may be quite computationally expensive, especially for large models such as a transformer, as compiling includes place and route activities to map the various computational tasks and data buffering to specific CGR units in the CGR array.

Methods, systems, and apparatuses are described herein that avoid the need to recompile a new computation graph with a specific classification head for each reuse of the pretrained backbone model. Thus, both the cost of the pretraining and the compilation can be shared among multiple applications of the backbone model.

The backbone model can be outfitted with a generic classification head that uses a number of classes large enough to cover any single application of the model. Then at the output of the generic classification head, a bias node is included to add a bias tensor (with a length equal to the number of classes in the generic classification head, to the output of the generic classification head before passing it to a probability distribution node. The computation graph with the backbone model, the generic classification head, the bias node, and the probability distribution node, is then compiled and stored for later use by specific applications.

A specific application may use the precompiled computation graph for a task that provides classification for a smaller number of classes, N, than provided by the generic classification head. To generate the specialized computation graph, a bias tensor is generated with a number of zero-valued entries equal to the number of classes used by the specific application, N, and the remainder of the bias tensor set to a negative number with a large magnitude, such as −1000000 or some other appropriate negative number. The precompiled computation graph can then be loaded into the SRDAP along with the pretrain weights and the bias tensor for finetune training. Note that the bias tensor effectively sets the probability of any of the unused classes to 0 after the probability distribution, so only the first N entries of the output of the probability distribution are used to classify inputs to one of the N classes.

### Terminology

As used herein, the phrase one of should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms comprising and consisting have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term coupled is used in an operational sense and is not limited to a direct or an indirect coupling. “Coupled to” is generally used in the sense of directly coupled, whereas “coupled with” is generally used in the sense of directly or indirectly coupled. “Coupled” in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term connected is used to indicate a direct connection, such as electrical, optical, electromagnetic, or mechanical, between the things that are connected, without any intervening things or devices.

The term configured (to perform a task or tasks) is a broad recitation of structure generally meaning “having circuitry that” performs the task or tasks during operation. As such, the described item can be configured to perform the task even when the unit/circuit/component is not currently on or active. In general, the circuitry that forms the structure corresponding to “configured to” may include hardware circuits, and may further be controlled by switches, fuses, bond wires, metal masks, firmware, and/or software. Similarly, various items may be described as performing a task or tasks, for convenience in the description. Such descriptions should be interpreted as including the phrase “configured to.” Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. $ 112, paragraph (f) interpretation for that element unless the language “means for” or “step for” is specifically recited.

As used herein, the term based on is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

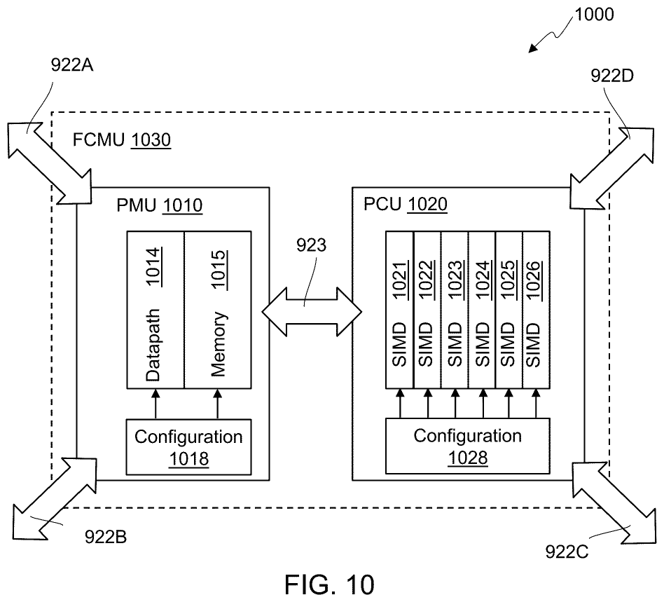

The following terms or acronyms used herein are defined at least in part as follows:
AGCU—address generator (AG) and coalescing unit (CU).
AI—artificial intelligence.
AIR—arithmetic or algebraic intermediate representation.
ALN—array-level network.
Buffer—an intermediate storage of data.
CGR—coarse-grained reconfigurable. A property of, for example, a system, a processor, an architecture (see CGRA), an array, or a unit in an array. This property distinguishes the system, etc., from field-programmable gate arrays (FPGAs), which can implement digital circuits at the gate level and are therefore fine-grained configurable.
CGRA—coarse-grained reconfigurable architecture. A data processor architecture that includes one or more arrays (CGR arrays) of CGR units.
SRDAP—statically reconfigurable dataflow architecture processor. A SRDAP is statically reconfigured to perform a particular function and does not sequentially fetch and execute instructions in time. Instead, the data path of the SRDAP is statically reconfigured by configuration data loaded into configuration stores of the SRDAP, e.g., flip-slops, registers. The configuration data may be referred to as a dataflow “program.” The dataflow program effectively maps a computation graph to the hardware of the SRDAP in a static fashion, rather than in a dynamic fashion as would be accomplished by traditional von Neumann architecture processor fetching and executing an instruction stream.
Compiler—a translator that processes statements written in a programming language to machine language instructions for a computer processor. A compiler may include multiple stages to operate in multiple steps. Each stage may create or update an intermediate representation (IR) of the translated statements. Compiler stages are illustrated with reference to FIG. 10.
Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms, input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.
CGR unit—a circuit that can be configured and reconfigured to locally store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.
CU—coalescing unit.
Dataflow Graph—a computation graph that includes one or more loops that may be nested, and wherein nodes can send messages to nodes in earlier layers to control the dataflow between the layers.
Datapath—a collection of functional units that perform data processing operations. The functional units may include memory, multiplexers, ALUs, SIMDs, multipliers, registers, buses, etc.
FCMU—fused compute and memory unit-a circuit that includes both a memory unit and a compute unit.
Graph—a collection of nodes connected by edges. Nodes may represent various kinds of items or operations, dependent on the type of graph. Edges may represent relationships, directions, dependencies, etc.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
A logical CGR array or logical CGR unit—a CGR array or a CGR unit that is physically realizable, but that may not have been assigned to a physical CGR array or to a physical CGR unit on an IC.
Metapipeline—a subgraph of a computation graph that includes a producer operator providing its output as an input to a consumer operator to form a pipeline. A metapipelines may be nested within another metapipeline, that is, producer operators and consumer operators may include other metapipelines.
ML—machine learning.
PCU—pattern compute unit—a compute unit that can be configured to repetitively perform a sequence of operations.
PEF—processor-executable format—a file format suitable for configuring a configurable data processor.
Pipeline—a staggered flow of operations through a chain of pipeline stages. The operations may be executed in parallel and in a time-sliced fashion. Pipelining increases overall instruction throughput. SRDAPs may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the SRDAP, CGR array level, and/or GCR unit level.
Pipeline Stages—a pipeline is divided into stages that are coupled with one another to form a pipe topology.
PMU—pattern memory unit—a memory unit that can locally store data according to a programmed pattern.
PNR—place and route—the assignment of logical CGR units and associated processing/operations to physical CGR units in an array, and the configuration of communication paths between the physical CGR units.
RAIL—reconfigurable dataflow unit (RDU) abstract intermediate language.
CGR Array—an array of CGR units, coupled with each other through an array-level network (ALN), and coupled with external elements via a top-level network (TLN). A CGR array can physically implement the nodes and edges of a dataflow graph.
SIMD—single-instruction multiple-data—an arithmetic logic unit (ALU) that simultaneously performs a single programmable operation on multiple data elements delivering multiple output results.
TLIR—template library intermediate representation.
TLN—top-level network.

### Implementations

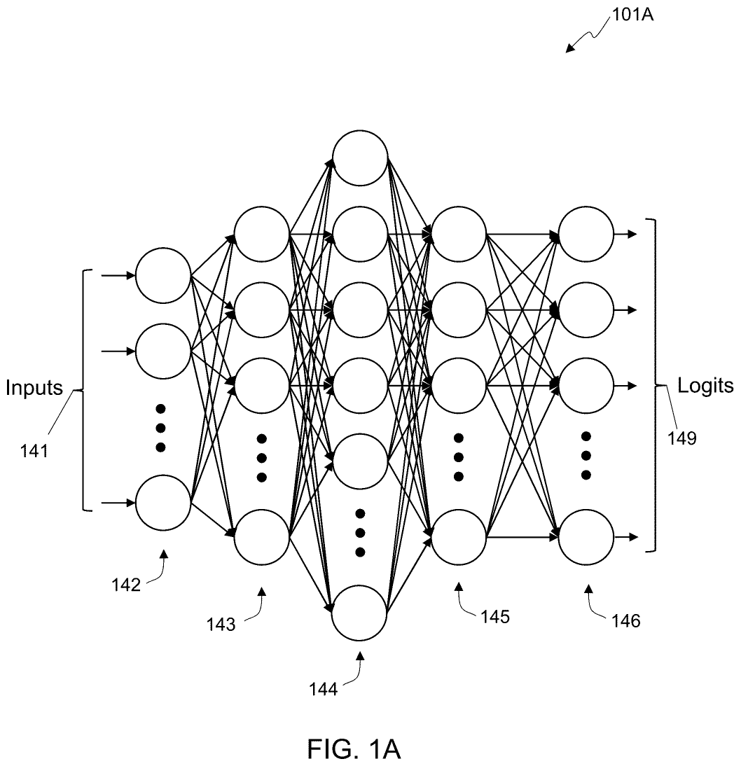

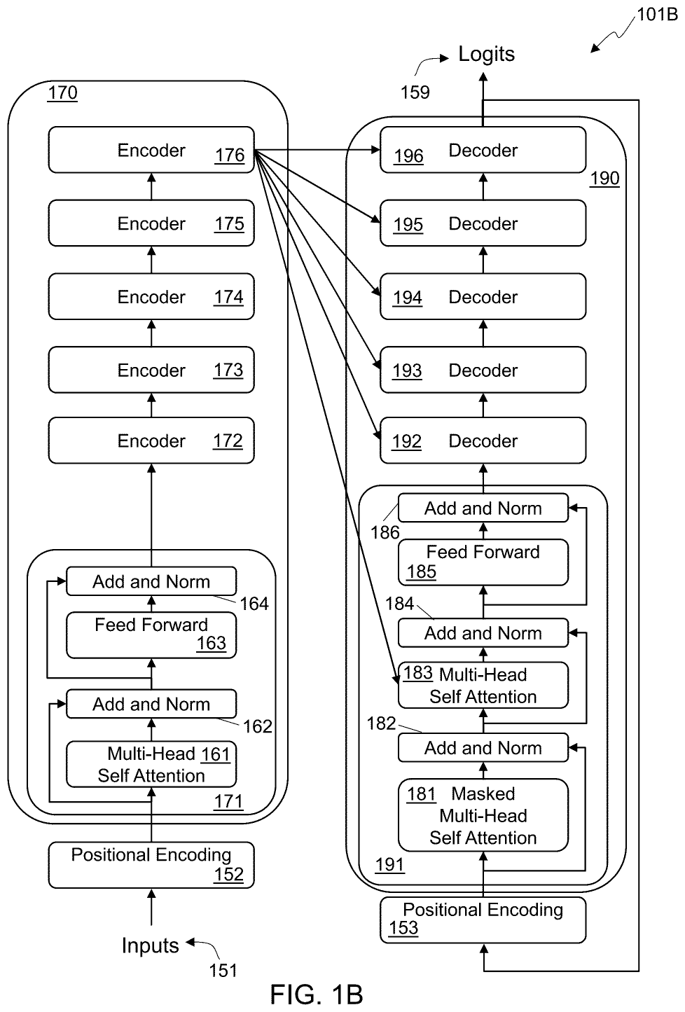

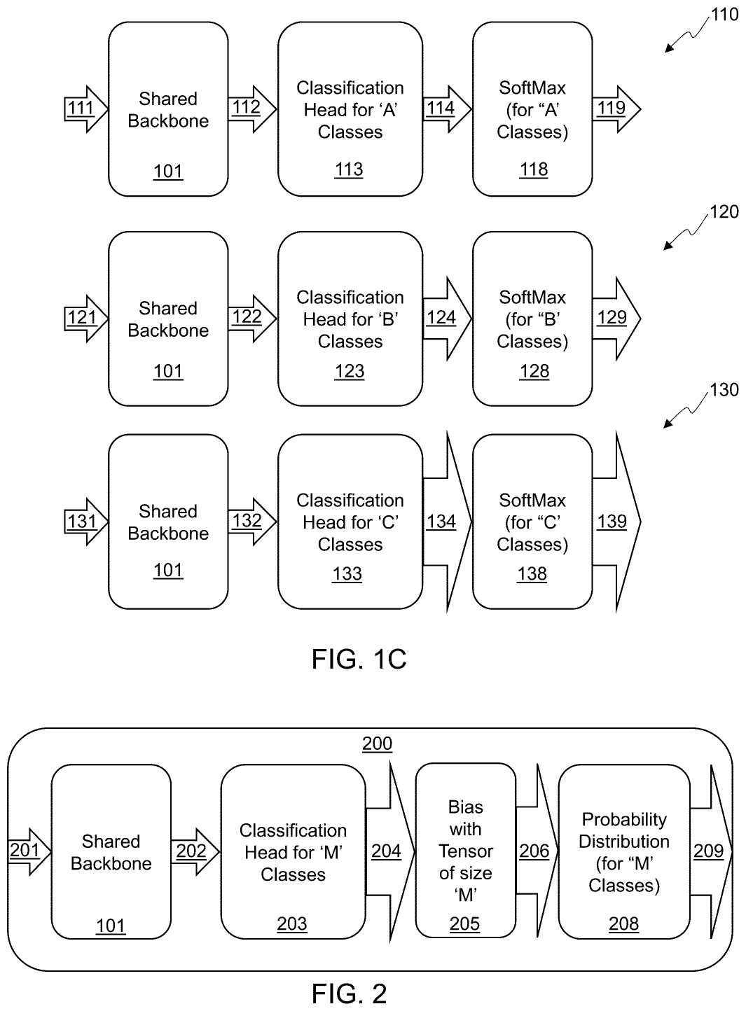

As described above, multiple computation graphs each configured to classify between a predetermined number of classes may be able to use a common, pre-trained, shared backbone. The shared backbone can be any type of computation graph, depending on the implementation. FIG. 1A shows a multilayer perceptron neural network (MLPNN) 101A suitable as a shared backbone for an implementation of a classification computation graph. The MLPNN 101A receives inputs 141 into an input layer 142. The MLPNN 101A can have any number of inputs, depending on the implementation. In the example shown, the MLPNN 101A has three hidden layers, a first hidden layer 143, a second hidden layer 144, and a third hidden layer 145 that are fully connected linear layers. Each of the hidden layers 143-145 can have any number of nodes, depending on the implementation. The MLPNN 101A also includes a linear output layer 146 which can generate logits 149 for the classification as outputs. The size of the output layer 146 is equal to the number of classes classified by the MLPNN 101A.

FIG. 1B shows a transformer neural network (TNN) 101B suitable as a shared backbone for an implementation of a classification computation graph. The TNN 101B is similar to the TNN disclosed in the paper by Ashish Vaswani et al., “Attention is all you need” from Advances in Neural Information Processing Systems 30, published in 2017, which is incorporated by reference herein. The TNN 101B receives inputs 151 which are encoded based on their position in the input by the positional encoding block 152 before passing to the encoder stack 170. The encoder stack 170 can include any number of encoders, such as the example shown with 6 encoders 171-176. Each additional encoder 172, 173, 174, 175, 176 may be constructed as shown for the first encoder 171 with a multi-head self-attention block 161 followed by an add and normalization block 162. Its output is then fed to a fully connected feed-forward network 163 followed by another add and normalization block 164.

The TNN 101B also includes a decoder stack 190 which can have any number of decoders, such as the example shown with 6 decoders 191-196. Each additional decoder 192, 193, 194, 195, 196 may be constructed as shown for the first decoder 191 with a masked multi-head self-attention block 181 to receive the output of the TNN 101B (shifted by one) which has been encoded based on their position in the output by the positional encoding block 153 before passing to the decoder stack 190. The output of the first add and normalization block 182 is passed to a second multi-head self-attention block 183 which uses it as one of its inputs with the output of the encoder stack 170 used for the other two inputs. Another add and normalization block 184 is included and its output is then fed to a fully connected feed-forward network 185 followed by another add and normalization block 186. The output of the decoder stack 190 provides logits 159 as the output of the TNN 101B.

FIG. 1C shows three implementations of classification computation graphs 110, 120, 130 using a shared backbone 101. The shared backbone can be any type of classification computation graph, including, but not limited to, a MLPNN 101A as shown in FIG. 1A, or a TNN 101B as shown in FIG. 1B. The shared backbone 101 may have been pretrained with a large set of training data covering a range of classes. The shared backbone 101 may have been set up for pretraining by adding a pretrain classification head for a large number of classes. A set of weights for the shared backbone 101 based on the pretraining may be available to initialize the shared backbone 101.

The three implementations of classification computation graphs 110, 120, 130 may be for three different classification tasks for different numbers of classes. The first implementation 110 may be configured to classify inputs 111 into ‘A’ classes. A classification head 113 for ‘A’ classes may be created for use with the shared backbone 101 which takes the output 112 of the shared backbone and generate ‘A’ logits 114 and provides them to a probability distribution node 118 for ‘A’ classes, such as a SoftMax function. The classification head 113 may include one or more linear layers or any other type of computation subgraph to convert the output of the shared backbone 101 to logits 114 for the ‘A’ classes. The probability distribution node 118 generates ‘A’ probabilities 119 of the input 111 being each one of the ‘A’ classes. The first implementation 110 can then be compiled and finetune trained for the ‘A’ classes to be used.

Similarly, the second implementation 120 may be configured to classify inputs 121 into ‘B’ classes and feeds the output 122 of the shared backbone 101 into a classification head for ‘B’ classes 123 to generate ‘B’ logits 124. The probability distribution node 128 generates ‘B’ probabilities 129 of the input 121 being each one of the ‘B’ classes. And the third implementation 130 may be configured to classify inputs 131 into ‘C’ classes by feeding the output 132 of the shared backbone 101 into a classification head for ‘C’ classes 133 to generate ‘C’ logits 134 with the probability distribution node 138 generating ‘C’ probabilities 139 of the input 131 being each one of the ‘C’ classes. The implementations 120, 130 can each then be complied and finetune trained.

Note that while the three implementations 110, 120, 130 can share the pretraining of the shared backbone, each of the three implementations 110, 120, 130 are separately compiled into configuration files for the target SRDAP using a CGRA. Compilation for this type of architecture can be a computationally expensive task and it may not be possible to share work done by the compiler between the different implementations 110, 120, 130.

FIG. 2 shows an implementation of a classification computation graph 200 with an added bias node 205 suitable for multiple classification tasks with different numbers of classes. The same shared backbone 101 may be used as for the three implementations 110, 120, 130 shown in FIG. 1C. A classification head 203 for a maximum number of classes ‘M” is created and configured to receive the output 202 of the shared backbone 101. Like the classification heads 113, 123, 133 shown in FIG. 1C, the classification head 203 may include one or more linear neural network layers, other neural networks, and/or other computation graph elements to generate ‘M’ logits 204 based on the output 202 of the shared backbone. A bias node 205 to add a tensor of size ‘M’ is then configured to receive the ‘M’ logits 204 and generate ‘M’ biased logits 206 which can then be provided to the probability distribution node 208 to generate ‘M’ probabilities for the input 201 to the computation graph 200.

The probability distribution node 208 can be any type of function that generates true probabilities or other indications of likelihood for the ‘M’ classes, even those that may not be a true probability ranging from 0%-100%. Examples of a probability distribution function that may be implemented by the probability distribution node 208 include, but are not limited to, a SoftMax function, a Taylor SoftMax function, a Soft-margin SoftMax function, or a Sigmoid function. The probability distribution function can map logits 206 that are larger than their peers to higher probabilities and smaller logits 206 (such as negative logits) to low probabilities.

The classification computation graph 200 can then be compiled and stored for later use. In some implementations, the shared backbone 101 may have been previously pretrained and have pretrain weights that can be stored along with the compiled computation graph 200. In other implementations, the compiled computation graph 200 may be used with a bias tensor of ‘M’ zeros (wo that the biased logits 206 are exactly equal to the logits 204 provided by the classification head 203) for the pretraining to generate the pretrain weights which can be stored for later use.

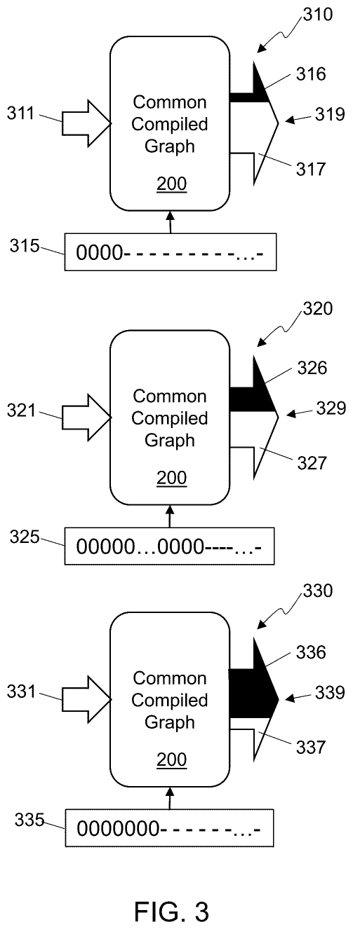

FIG. 3 shows three implementations of classification computation graphs 310, 320, 330 using a common compiled graph 200 as described in FIG. 2. The common compiled graph 200 may be retrieved from computer storage and used for the three implementations 310, 320, 330 for classifying the respective inputs 311, 321, 331 into predetermined number of classes. In the first implementation 310, the inputs 311 are to be classified into 4 classes. A bias tensor 315 with M entries is generated where the first four entries have zero values and the remining M−4 entries are set to a negative value. The common compiled graph 200 is loaded into the SRDAP along with the pretrain weights and the bias tensor 315 and finetune training data for 4 classes is then used to finetune train the graph 200 and update the weights. The output of the graph is a set of probability values 319 where the first 4 entries 316 are the probabilities of an input being in each of the 4 classes and the remaining M−4 entries 317 are zero (or very small). Thus, the common compiled graph 200 can be used to classify inputs 311 into 4 classes without recompilation of the graph 200.

The second implementation 320 is configured to classify inputs 321 into 7 classes. A bias tensor 325 is generated with 7 zero values followed by M−7 negative values and the common compiled graph 200 is loaded into the SRDAP along with the pretrain weights and the bias tensor 325. Finetune training data for the 7 classes is then used to finetune train the graph 200 and update the weights. The output of the graph is a set of probability values 329 where the first 7 entries 326 are the probabilities of an input being in each of the 7 classes and the remaining M−7 entries 327 are zero (or very small). Thus, the same common compiled graph 200 as was used for classification into 4 classes can be used to classify inputs 331 into 7 classes without recompilation of the graph 200.

The third implementation 330 is configured to classify inputs 331 into N classes. A bias tensor 335 is generated with N zero values followed by M−N negative values and the common compiled graph 200 is loaded into the SRDAP along with the pretrain weights and the bias tensor 335. Finetune training data for the N classes is then used to finetune train the graph 200 and update the weights. The output of the graph is a set of probability values 339 where the first N entries 336 are the probabilities of an input being in each of the 7 classes and the remaining M−N entries 337 are zero (or very small). Thus, the same common compiled graph 200 can be used to classify inputs 331 into various numbers of classes without recompilation of the graph 200.

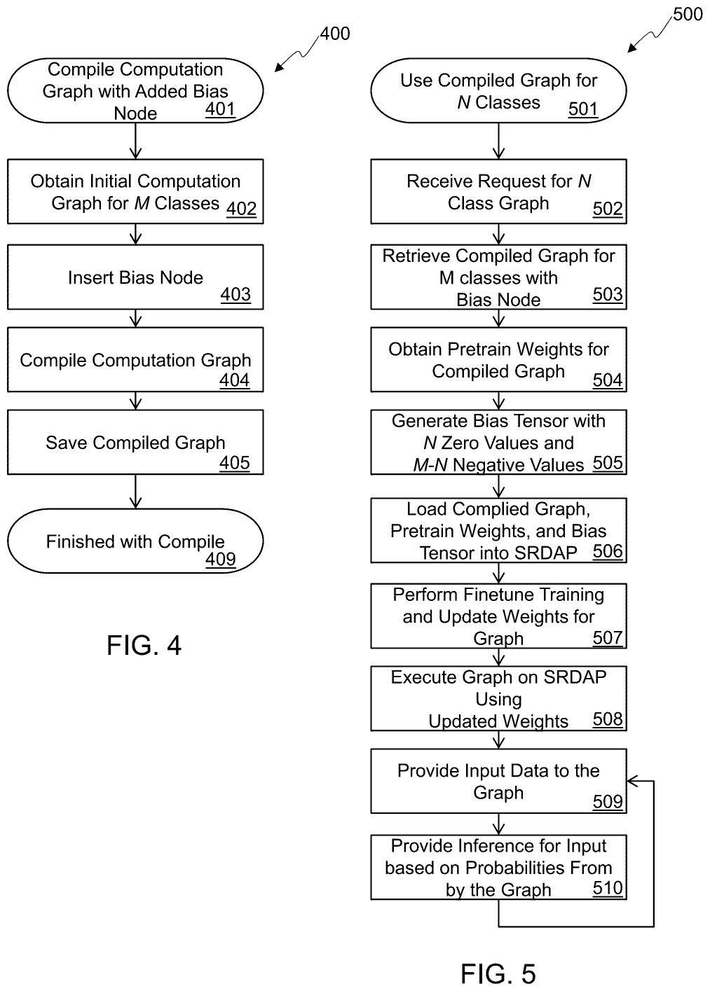

FIG. 4 is a flowchart 400 for an implementation of a method to generate a common compiled graph suitable for multiple classification tasks with different numbers of classes. The flowchart 400 for the method to compile 401 a computation graph with an added bias node includes obtaining 402 an initial computation graph including a classification neural network providing M logits where M is a positive integer value that it at least as large as the largest number of classes that will be classified using this graph. The classification neural network may be any time of classification neural network, such as, but not limited to, a transformer neural network, a long short term memory neural network, a recurrent neural network, and/or a multilayer perceptron neural network with one or more hidden layers inserting the bias node between the classification neural network and the probability distribution node to create the computation graph. The computation graph also includes a probability distribution node, which may be a SoftMax function or any other sort of function that normalizes the logits to represent a probability function.

The method continues with inserting 403 a bias node between the classification neural network and the probability distribution node to create the computation graph. The bias node provides a biased tensor of size M to the probability distribution node by adding a bias tensor to a calculated tensor received from the classification neural network. The computation graph, including the classification neural network, the bias node, and the probability distribution node is then compiled 404 to generate the common compiled graph which is then saved 405 for later use. The method to generate the common compiled graph is then finished 409.

FIG. 5 is a flowchart 500 for an implementation of a computer-implemented method to use 501 a static compilation of a computation graph (i.e., a common compiled graph) to classify a specific number, N, of classes where N is a positive integer. Because the common compiled graph can be reused for different N values, the method is also for reusing the static compilation of the computation graph. The static compilation of a computation graph can be targeted to run on a statically reconfigurable dataflow architecture processor (SRDAP) using a coarse-grained reconfigurable architecture (CGRA).

The method includes receiving 502 a first request to generate a first instantiation of the computation graph to generate a first probability distribution for N classes and continues by retrieving 503 a compiled graph of the computation graph from a computer memory. The computation graph includes a classification neural network, a bias node, and a probability distribution node for M classes, where M is a positive integer greater than N. The classification neural network can include, as non-limiting examples, a transformer neural network, a long short term memory neural network, a recurrent neural network, and/or a multilayer perceptron neural network with one or more hidden layers. The bias node provides a biased tensor of size M to the probability distribution node by adding a bias tensor to a calculated tensor which is received from a classification neural network of the computation graph. The probability distribution node may implement a SoftMax function in some implementations.

Pretrain weights for the compiled graph are also obtained 504. In some implementations, the pretraining has already been performed and the weights are retrieved from computer memory. In other implementations, the pretraining may be performed on the compiled graph and may then be stored for later use.

A first bias tensor is generated 505 having N entries equal to zero and M−N entries having negative values. In some implementations the M−N negative entries of the first bias tensor each have an absolute value that is at least one order of magnitude greater than N. Implementations may generate the first bias tensor to have the first M entries equal to zero followed by M−N entries equal to a predetermined negative number. The M−N negative entries may be set equal to a minimum negative value (i.e., the negative number with the largest absolute value) representable by a data type used for the first bias tensor, such as −2,147,483,648 if 32 bit integers are used or approximately −3.4028235×10³⁸ if a single-precision floating-point format is used. Any negative number with a sufficiently large magnitude may be used and may be the same for all negative entries of the bias tensor or different negative values may be used for the various negative entries of the bias tensor.

The method also includes loading 506 the compiled graph with the first bias tensor as the bias tensor for the bias node into a first set coarse-grained reconfigurable (CGR) units of the SRDAP as the first instantiation of the computation graph. The compiled graph has a first subset of the first set of CGR units of the SRDAP assigned to the bias node and a second subset of the first set of CGR units of the SRDAP assigned to the probability distribution node. A set of weights for the computation graph may also be loaded into the SRDAP with the compiled graph. The set of weights for the computation graph may include pretrain weights determined by pre-training the computation graph.

In some implementations finetune training of the first instantiation of the computation graph may be performed 507 to update the set of weights for the computation graph so the set of weights for the computation graph includes weights determined by pre-training and then finetune training the computation graph. In other cases, the set of weights for the computation graph obtained may already include weights determined by pre-training and then finetune training the computation graph. In yet other cases, no finetune training may be performed and the weights used as they are obtained.

The first instantiation of the computation graph is then executed 508 on the SRDAP to generate the first probability distribution, wherein the first probability distribution comprises N entries of a first output of the probability distribution node of the first instantiation of the computation graph corresponding to the N entries equal to zero in the first bias tensor. Input data is provided 509 to the graph for classification and a first inference provided 510 for at least one portion of the input data based on the first probability distribution. New inferences may be provided 510 as new input data is provided 510 until execution of the graph on the SRDAP is halted.

In some cases, a second request may be received to generate a second instantiation of the computation graph to generate a second probability distribution for R classes, wherein R is a positive integer different than N and less than M. A second bias tensor may be generated having R entries equal to zero and by M−R entries having negative values. The compiled graph is again retrieved and loaded with the second bias tensor as the bias tensor for the bias node into a second set of CGR units of the SRDAP as the second instantiation of the computation graph. The second instantiation of the computation graph can then be executed on the SRDAP to generate the second probability distribution, wherein second probability distribution includes R entries of a second output of the probability distribution node of the second instantiation of the computation graph corresponding to the R entries equal to zero in the second bias tensor. A second inference can then be provided based on the second probability distribution.

The architecture, configurability, and dataflow capabilities of an array of CGR units enable increased compute power that supports both parallel and pipelined computation. A SRDAP, which includes one or more CGR arrays (arrays of CGR units), can be programmed to simultaneously execute multiple independent and interdependent dataflow graphs. To enable simultaneous execution, the dataflow graphs may need to be distilled from a high-level program and translated to a configuration file for the SRDAP. A high-level program is source code written in programming languages like Spatial, Python, C++, and C, and may use computation libraries for scientific computing, ML, AI, and the like. The high-level program and referenced libraries can implement computing structures and algorithms of machine learning models like AlexNet, VGG Net, GoogleNet, ResNet, ResNeXt, RCNN, YOLO, SqueezeNet, SegNet, GAN, BERT, ELMo, USE, Transformer, and Transformer-XL.

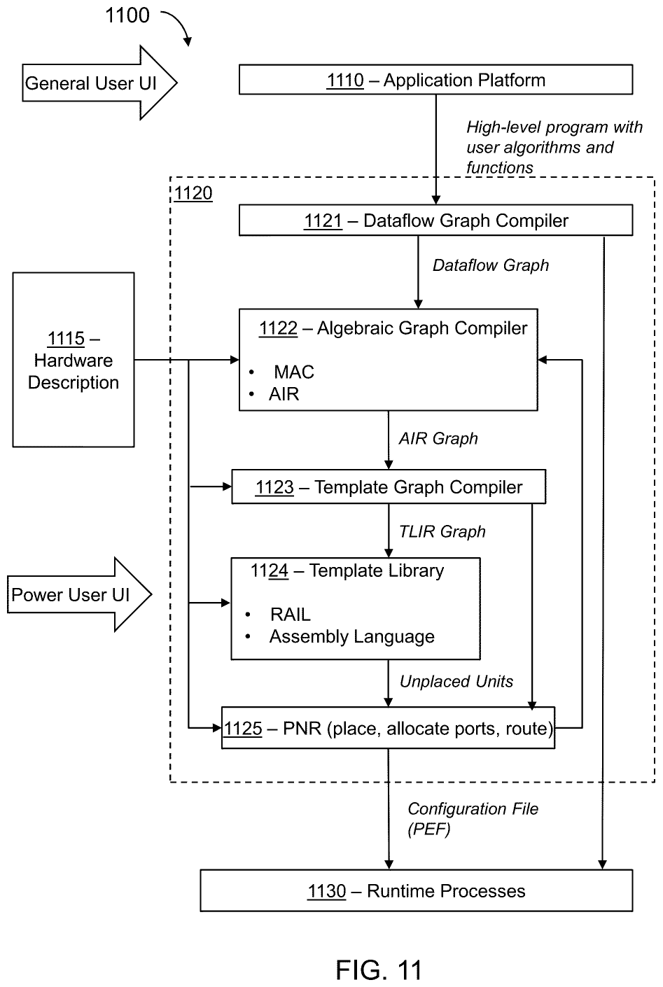

Translation of high-level programs to executable bit files is performed by a compiler, see, for example, FIGS. 11-16. While traditional compilers sequentially map operations to processor instructions, typically without regard to pipeline utilization and duration (a task usually handled by the hardware), an array of CGR units requires mapping operations to processor instructions in both space (for parallelism) and time (for synchronization of interdependent computation graphs or dataflow graphs). This requirement implies that a compiler for a CGRA must decide which operation of a computation graph or dataflow graph is assigned to which of the CGR units, and how both data and, related to the support of dataflow graphs, control information flows among CGR units, and to and from external hosts and storage. This process, known as “place and route”, is one of many new challenges posed to compilers for arrays of CGR units.

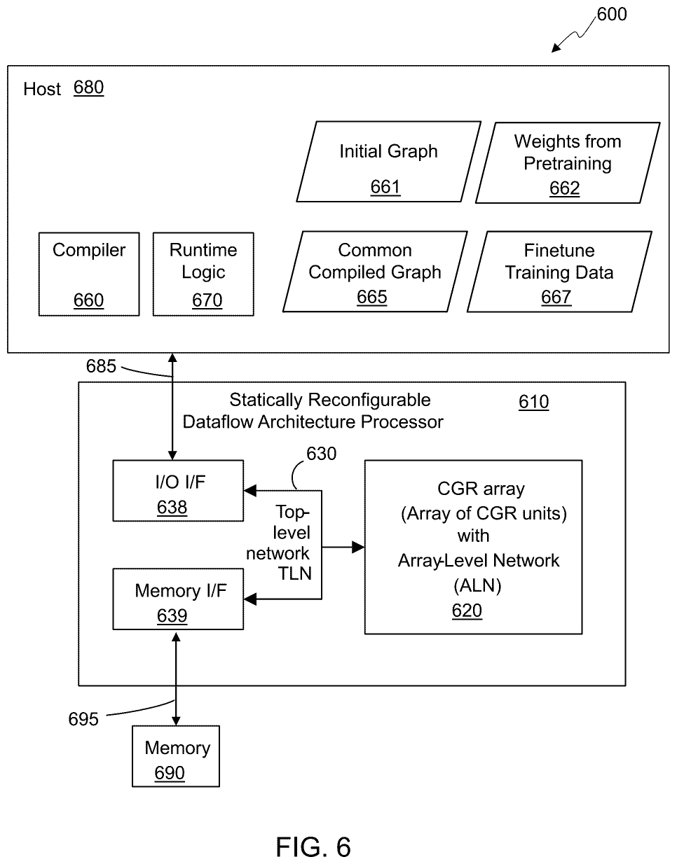

FIG. 6 illustrates an example system 600 including a statically reconfigurable dataflow architecture processor (SRDAP) 610, a host 680, and a memory 690. SRDAP 610 has a coarse-grained reconfigurable architecture (CGRA) and includes an array of CGR units 620 such as a CGR array. SRDAP 610 further includes an IO interface 638, and a memory interface 639. An array of CGR units 620 is coupled with IO interface 638 and memory interface 639 via data bus 630 which may be part of a top-level network (TLN). Host 680 communicates with IO interface 638 via system data bus 685, and memory interface 639 communicates with memory 690 via memory bus 695. The array of CGR units 620 may further include compute units and memory units that are connected with an array-level network (ALN) to provide the circuitry for execution of a computation graph or a dataflow graph that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the graph(s) may involve using multiple units of SRDAP 610. In some implementations, SRDAP 610 may include one or more ICs. In other implementations, a single IC may span multiple SRDAPs. In further implementations, SRDAP 610 may include one or more units of array of CGR units 620.

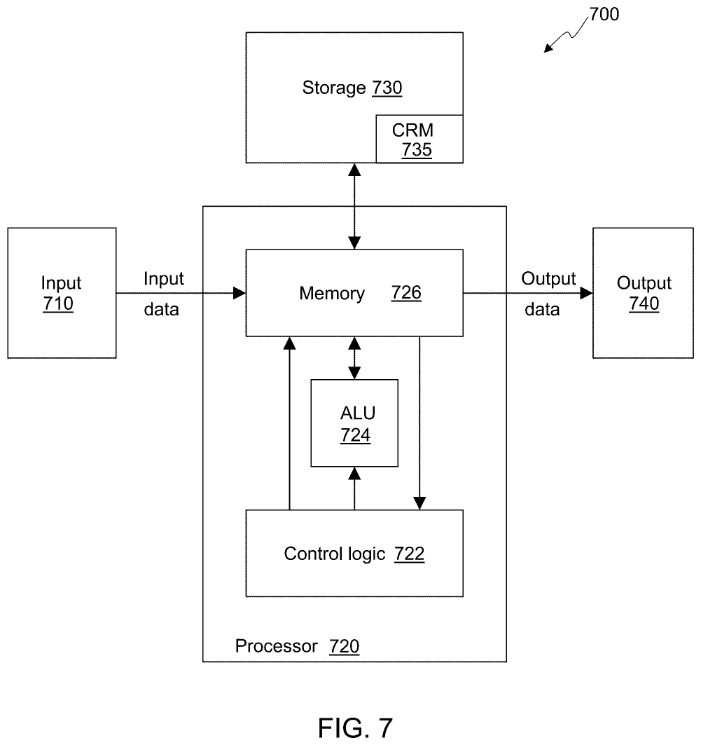

Host 680 may be, or include, a computer such as further described with reference to FIG. 7. Host 680 runs runtime processes, as further referenced herein, and may also be used to run computer programs, such as the compiler 660 further described herein with reference to FIG. 11. In some implementations, the compiler may run on a computer that is similar to the computer described with reference to FIG. 7 but separate from host 680.

SRDAP 610 may accomplish computational tasks by executing a configuration file (for example, a PEF file) which may be referred to as a common compiled graph 665 herein. For the purposes of this description, a configuration file corresponds to a dataflow graph, or a translation of a dataflow graph, and may further include initialization data. A compiler 660 compiles a high-level program to provide the common compiled graph 665. Runtime processes 670 may install the configuration file, which may be at least a part of the common compiled graph 665, in SRDAP 610. The host 680 may also store the initial graph 661 in uncompiled form as well as weights 662 from pretraining at least a portion of the initial graph 661. In some cases, the host may store, or have access to, finetune training data 667 which may be used for finetune training the common compiled graph 665 once it has been loaded into the SRDAP 610.

In some implementations described herein, a CGR array is configured by programming one or more configuration stores with all or parts of the common compiled graph 665. A single configuration store may be at the level of the SRDAP 610 or the CGR array 620, or a CGR unit may include an individual configuration store. The common compiled graph 665 may include configuration data for the CGR array 620 and CGR units in the CGR array 620, and link the computation graph to the CGR array 620. Execution of the configuration file by SRDAP 610 causes the CGR array 620 to implement the user algorithms and functions in the dataflow graph.

SRDAP 610 can be implemented on a single integrated circuit die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

So, a system can include one or more processors (such as in the host 680) and a statically reconfigurable dataflow processor (SRDAP) 610 coupled to the one or more processors. The one or more processors may be programmed to receive a first request to generate a first instantiation of a computation graph to generate a first probability distribution for N classes, wherein N is a positive integer. The one or more processors may also be programmed to retrieve a compiled graph 665 of the computation graph from a computer memory, the computation graph including a bias node and a probability distribution node for M classes, wherein M is a positive integer greater than N and the bias node provides a biased tensor of size M to the probability distribution node by adding a bias tensor to a calculated tensor. In addition, the one or more processors may also be programmed to generate a first bias tensor having N entries equal to zero and M−N entries having negative values and load the compiled graph 665 with the first bias tensor as the bias tensor for the bias node into a first set coarse-grained reconfigurable (CGR) units of the SRDAP 610 as the first instantiation of the computation graph. Execution of the first instantiation of the computation graph on the SRDAP 610 to generate the first probability distribution may then be initiated by the one or more processors, wherein the first probability distribution comprises N entries of a first output of the probability distribution node of the first instantiation of the computation graph corresponding to the N entries equal to zero in the first bias tensor, and the processors may then provide a first inference based on the first probability distribution.

FIG. 7 illustrates an example of a computer 700, including an input device 710, a processor 720, a storage device 730, and an output device 740. Although the example computer 700 is drawn with a single processor, other implementations may have multiple processors. Input device 710 may comprise a mouse, a keyboard, a sensor, an input port (for example, a universal serial bus (USB) port), and any other input device known in the art. Output device 740 may comprise a monitor, printer, and any other output device known in the art. Furthermore, part or all of input device 710 and output device 740 may be combined in a network interface, such as a Peripheral Component Interconnect Express (PCIe) interface suitable for communicating with SRDAP 610. Input device 710 is coupled with processor 720 to provide input data, which an implementation may store in memory 726. Processor 720 is coupled with output device 740 to provide output data from memory 726 to output device 740. Processor 720 further includes control logic 722, operable to control memory 726 and arithmetic and logic unit (ALU) 724, and to receive program and configuration data from memory 726. Control logic 722 further controls exchange of data between memory 726 and storage device 730. Memory 726 typically comprises memory with fast access, such as static random-access memory (SRAM), whereas storage device 730 typically comprises memory with slow access, such as dynamic random-access memory (DRAM), flash memory, magnetic disks, optical disks, and any other memory type known in the art. At least a part of the memory in storage device 730 includes a non-transitory computer-readable medium (CRM 735), such as used for storing computer programs.

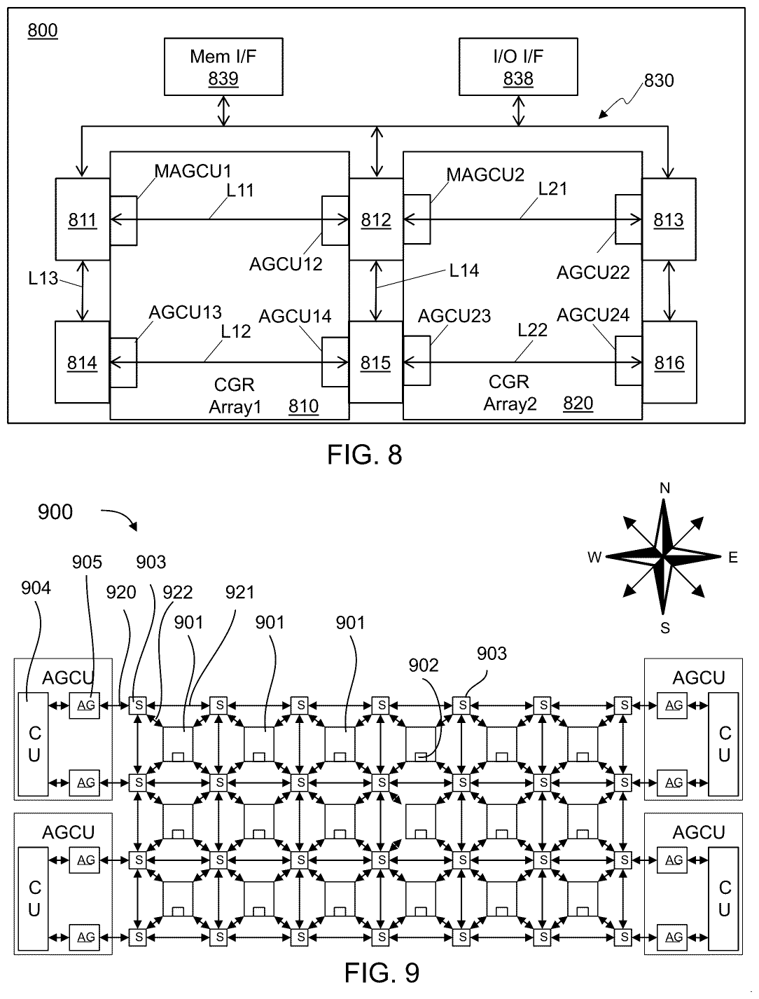

FIG. 8 illustrates example details of a CGR architecture 800 including a top-level network (TLN 830) and two CGR arrays (CGR array 810 and CGR array 820). A CGR array comprises an array of CGR units (e.g., PMUs, PCUs, FCMUs) coupled via an array-level network (ALN), e.g., a bus system. The ALN is coupled with the TLN 830 through several AGCUs, and consequently with I/O interface 838 (or any number of interfaces) and memory interface 839. Other implementations may use different bus or communication architectures.

Circuits on the TLN in this example include one or more external I/O interfaces, including I/O interface 838 and memory interface 839. The interfaces to external devices include circuits for routing data among circuits coupled with the TLN and external devices, such as high-capacity memory, host processors, other SRDAPs, FPGA devices, and so on, that are coupled with the interfaces.

Each depicted CGR array has four AGCUs (e.g., MAGCU1, AGCU12, AGCU13, and AGCU14 in CGR array 810). The AGCUs interface the TLN to the ALNs and route data from the TLN to the ALN or vice versa. Other implementations may have different numbers of AGCUs.

One of the AGCUs in each CGR array in this example is configured to be a master AGCU (MAGCU), which includes an array configuration load/unload controller for the CGR array. The MAGCU1 includes a configuration load/unload controller for CGR array 810, and MAGCU2 includes a configuration load/unload controller for CGR array 820. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

The TLN is constructed using top-level switches (switch 811, switch 812, switch 813, switch 814, switch 815, and switch 816) coupled with each other as well as with other circuits on the TLN, including the AGCUs, and external I/O interface 838. The TLN includes links (e.g., L11, L12, L21, L22) coupling the top-level switches. Data may travel in packets between the top-level switches on the links, and from the switches to the circuits on the network coupled with the switches. For example, switch 811 and switch 812 are coupled by link L11, switch 814 and switch 815 are coupled by link L12, switch 811 and switch 814 are coupled by link L13, and switch 812 and switch 813 are coupled by link L21. The links can include one or more buses and supporting control lines, including for example a chunk-wide bus (vector bus). For example, the top-level network can include data, request and response channels operable in coordination for transfer of data in any manner known in the art.

FIG. 9 illustrates an example CGR array 900, including an array of CGR units in an ALN. CGR array 900 may include several types of CGR unit 901, such as AGCUs, switches, FCMUs, PMUs, PCUs, memory units, and/or compute units. For examples of the functions of these types of CGR units, see Prabhakar et al., “Plasticine: A Reconfigurable Architecture for Parallel Patterns”, ISCA 2017 June 24-28, 2017, Toronto, ON, Canada. Each of the CGR units may include a configuration store 902 comprising a set of registers or flip-flops storing configuration data that represents the setup and/or the sequence to run a program, and that can include the number of nested loops, the limits of each loop iterator, the instructions to be executed for each stage, the source of operands, and the network parameters for the input and output interfaces. In some implementations, each CGR unit 901 comprises an FCMU. In other implementations, the array comprises both PMUs and PCUs, or memory units and compute units, arranged in a checkerboard pattern. In yet other implementations, CGR units may be arranged in different patterns. The ALN includes switch units 903 (S), and AGCUs (each including two address generators 905 (AG) and a shared coalescing unit 904 (CU)). Switch units 903 are connected among themselves via interconnects 921 and to a CGR unit 901 with interconnects 922. Switch units 903 may be coupled with address generators 905 via interconnects 920. In some implementations, communication channels can be configured as end-to-end connections, and switch units 903 are CGR units. In other implementations, switches route data via the available links based on address information in packet headers, and communication channels establish as and when needed.

A configuration file may include configuration data representing an initial configuration, or starting state, of each of the CGR units that execute a high-level program with user algorithms and functions. Program load is the process of setting up the configuration stores in the CGR array based on the configuration data to allow the CGR units to execute the high-level program. Program load may also require loading memory units and/or PMUs.

The ALN includes one or more kinds of physical data buses, for example a chunk-level vector bus (e.g., 512 bits of data), a word-level scalar bus (e.g., 32 bits of data), and a control bus. For instance, interconnects 921 between two switches may include a vector bus interconnect with a bus width of 512 bits, and a scalar bus interconnect with a bus width of 32 bits. A control bus can comprise a configurable interconnect that carries multiple control bits on signal routes designated by configuration bits in the CGR array's configuration file. The control bus can comprise physical lines separate from the data buses in some implementations. In other implementations, the control bus can be implemented using the same physical lines with a separate protocol or in a time-sharing procedure.

Physical data buses may differ in the granularity of data being transferred. In one implementation, a vector bus can carry a chunk that includes 16 channels of 32-bit floating-point data or 32 channels of 16-bit floating-point data (i.e., 512 bits) of data as its payload. A scalar bus can have a 32-bit payload and carry scalar operands or control information. The control bus can carry control handshakes such as tokens and other signals. The vector and scalar buses can be packet-switched, including headers that indicate a destination of each packet and other information such as sequence numbers that can be used to reassemble a file when the packets are received out of order. Each packet header can contain a destination identifier that identifies the geographical coordinates of the destination switch unit (e.g., the row and column in the array), and an interface identifier that identifies the interface on the destination switch (e.g., North, South, East, West, etc.) used to reach the destination unit.

A CGR unit 901 may have four ports (as drawn) to interface with switch units 903, or any other number of ports suitable for an ALN. Each port may be suitable for receiving and transmitting data, or a port may be suitable for only receiving or only transmitting data.

A switch unit, as shown in the example of FIG. 9, may have eight interfaces. The North, South, East and West interfaces of a switch unit may be used for links between switch units using interconnects 921. The Northeast, Southeast, Northwest, and Southwest interfaces of a switch unit may each be used to make a link with an FCMU, PCU or PMU instance using one of the interconnects 922. Two switch units in each CGR array quadrant have links to an AGCU using interconnects 920. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more links between the switch units to the CGR units using the vector bus and vector interface(s) of the one or more switch units on the ALN. A CGR array may comprise at least a part of CGR array 900, and any number of other CGR arrays coupled with CGR array 900.

A data processing operation implemented by CGR array configuration may comprise multiple graphs or subgraphs specifying data processing operations that are distributed among and executed by corresponding CGR units (e.g., FCMUs, PMUs, PCUs, AGs, and CUs).

FIG. 10 illustrates an example 1000 of a PMU 1010 and a PCU 1020, which may be combined in an FCMU 1030. PMU 1010 may be directly coupled to PCU 1020 through one or more ALN interconnects 923, or optionally via links through one or more switches. The FCMU 1030 includes multiple ALN interconnects, such as NW ALN interconnect 922A and SW ALN interconnect 922B, which may connect to PMU 1010, and SE ALN interconnect 922C and NE ALN interconnect 922D, which may connect to PCU 1020. The NW ALN interconnect 922A, SW ALN interconnect 922B, SE ALN interconnect 922C, and NE ALN interconnect 922D connect to switches 903 as shown in FIG. 9. Each ALN interconnect 922A-922C, 923 includes one or more scalar interconnects, one or more vector interconnects, and one or more control interconnects where an individual interconnect may be unidirectional into the FCMU 1030, unidirectional out of the FCMU 1030 or bidirectional. The FCMU 1030 can include FIFOs to buffer data entering and/or leaving the FCMU 1030 on the interconnects.

PMU 1010 includes configuration store 1018 which provides configuration data for the PMU 1010. The configuration store 1018 can be loaded from a program running on the host 680 (as shown in FIG. 6) and can configure the data path 1014 to generate address information for a scratchpad memory 1015, based on data received through one or more of the ALN interconnects 922A, 922B, 923. Data received through one or more ALN interconnects 922A, 922B, 923 may be written to the scratchpad memory 1015 at addresses generated by the data path 1014 and/or data read from the scratchpad memory 1015 at addresses generated by the data path 1014 may be sent out on the one or more ALN interconnects 922A, 922B, 923 to the PCU 1020 and/or to one or more other CGR units in the CGR array 900.

PCU 1020 includes two or more processor stages, such as SIMD 1021 through SIMD 1026, and configuration store 1028. The processor stages may include ALUs, or SIMDs, as drawn, or any other reconfigurable stages that can process data. Data may be received through one or more ALN interconnects 922C, 922D, 923, processed by the two or more processor stages, SIMD 1021-SIMD 1026 and then sent out to the PMU 1010 or another CGR unit of the CGR array 900 through one or more ALN interconnects 922C, 922D, 923. The SIMD 1021 through SIMD 1026 may have a number of lanes of processing that is equal to the number of lanes of data provided by a vector interconnect of the ALN interconnects 922C, 922D, 923. Each stage in PCU 1020 may also hold one or more registers (not drawn) for short-term storage of parameters. Short-term storage, for example during one to several clock cycles or unit delays, allows for synchronization of data in the PCU pipeline.

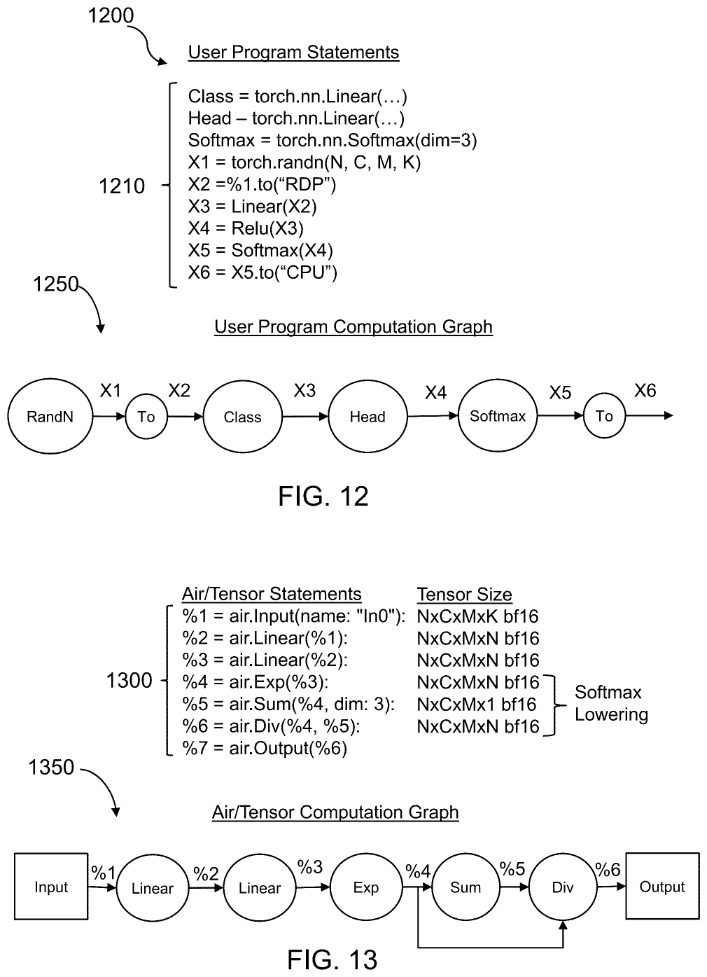

FIG. 11 is a block diagram of a compiler stack 1100 implementation suitable for generating a configuration file for a SRDAP. FIGS. 12-16 illustrate various representations of an example user program 1200 corresponding to various stages of a compiler stack such as compiler stack 1100. As depicted, compiler stack 1100 includes several stages to convert a high-level program (e.g., user program 1200) with statements 1210 that define user algorithms and functions, e.g., algebraic expressions and functions, to configuration data for the CGR units. The example user program 1200 depicted in FIG. 12 comprises statements 1210 that invoke various PyTorch functions.

Compiler stack 1100 may take its input from application platform 1110, or any other source of high-level program statements suitable for parallel processing, which provides a user interface for general users. It may further receive hardware description 1115, for example defining the physical units in a reconfigurable data processor or CGRA processor. Application platform 1110 may include libraries such as PyTorch, TensorFlow, ONNX, Caffe, and Keras to provide user-selected and configured algorithms.

Application platform 1110 outputs a high-level program to compiler 1120, which in turn outputs a configuration file to the reconfigurable data processor or CGRA processor where it is executed in runtime processes 1130. Compiler 1120 may include dataflow graph compiler 1121, which may handle a dataflow graph, algebraic graph compiler 1122, template graph compiler 1123, template library 1124, and placer and router PNR 1125. In some implementations, template library 1124 includes RDU abstract intermediate language (RAIL) and/or assembly language interfaces for power users.

Dataflow graph compiler 1121 converts the high-level program with user algorithms and functions from application platform 1110 to one or more dataflow graphs. The high-level program may be suitable for parallel processing, and therefore parts of the nodes of the dataflow graphs may be intrinsically parallel unless an edge in the graph indicates a dependency. Dataflow graph compiler 1121 may provide code optimization steps like false data dependency elimination, dead-code elimination, and constant folding. The dataflow graphs encode the data and control dependencies of the high-level program. Dataflow graph compiler 1121 may support programming a reconfigurable data processor at higher or lower-level programming languages, for example from an application platform 1110 to C++ and assembly language. In some implementations, dataflow graph compiler 1121 allows programmers to provide code that runs directly on the reconfigurable data processor. In other implementations, dataflow graph compiler 1121 provides one or more libraries that include predefined functions like linear algebra operations, element-wise tensor operations, non-linearities, and reductions required for creating, executing, and profiling the dataflow graphs on the reconfigurable processors. Dataflow graph compiler 1121 may provide an application programming interface (API) to enhance functionality available via the application platform 1110.

FIG. 12 shows an example user program 1200 in an example first stage of the compiler stack. User program 1200 generates a random tensor X1 with a normal distribution in the RandN node. It provides the tensor to a neural network cell that performs a classification function (in the Linear node) followed by a classification head function, which is followed by a SoftMax activation function, for example to normalize the output to a probability distribution over a predicted output class. Note that the classification function and head are simplified over what would typically be done in real classification neural networks for clarity. FIG. 12 does not show the weights and bias used for the weighing function. User program 1200 corresponds with computation graph 1250.

Algebraic graph compiler 1122 may include a model analyzer and compiler (MAC) level that makes high-level mapping decisions for (sub-graphs of the) dataflow graph based on hardware constraints. It may support various application frontends such as Samba, JAX, and TensorFlow/HLO. Algebraic graph compiler 1122 may also transform the graphs via autodiff and GradNorm, perform stitching between sub-graphs, interface with template generators for performance and latency estimation, convert dataflow graph operations to AIR operation, perform tiling, sharding (database partitioning) and other operations, and model or estimate the parallelism that can be achieved on the dataflow graphs.

Algebraic graph compiler 1122 may further include an arithmetic or algebraic intermediate representation (AIR) level that translates high-level graph and mapping decisions provided by the MAC level into explicit AIR/Tensor statements 1300 (see FIG. 13) and one or more corresponding algebraic graphs 1350. Key responsibilities of the AIR level include legalizing the graph and mapping decisions of the MAC, expanding data parallel, tiling, metapipe, region instructions provided by the MAC, inserting stage buffers and skip buffers, eliminating redundant operations, buffers and sections, and optimizing for resource use, latency, and throughput.

FIG. 13 shows the user program 1200 in an example second stage of the compiler stack. At this stage, the algebraic graph compiler replaces the SoftMax macro by its constituents. The SoftMax function is given as

$$\frac{{e}^{\{ {z}_{i} \}}}{{\sum }_{j = 1}^{K} {e}^{\{ {z}_{j} \}}} .$$

This function includes an exponential component, a summation, and a division. Thus, algebraic graph compiler 1122 replaces the user program statements 1210, also shown as computation graph 1250, by AIR/Tensor statements 1300, also shown as Air/Tensor computation graph 1350.

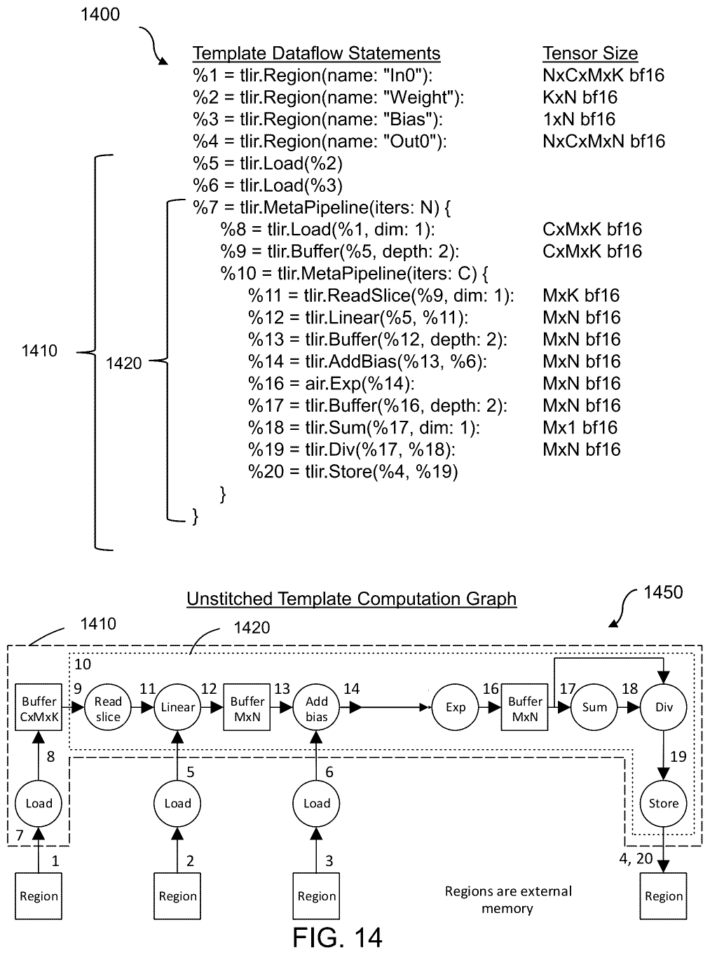

Template graph compiler 1123 may translate AIR statements and/or graphs into TLIR statements 1400 (see FIG. 14) and/or graphs (graph 1450 is shown), optimizing for the target hardware architecture into unplaced variable-sized units (referred to as logical CGR units) suitable for PNR 1125. In the example shown, the two Linear nodes for classification and head have been combined into one linear node for clarity. In implementations, the two linear nodes may be kept separate or broken into smaller steps. Template graph compiler 1123 may allocate metapipelines, such as metapipeline 1410 and metapipeline 1420, for sections of the template dataflow statements 1400 and corresponding sections of unstitched template computation graph 1450. Template graph compiler 1123 may add further information (name, inputs, input names and dataflow description) for PNR 1125 and make the graph physically realizable through each performed step. Template graph compiler 1123 may for example provide translation of AIR graphs to specific model operation templates such as for general matrix multiplication (GeMM). An implementation may convert part or all intermediate representation operations to templates, stitch templates into the dataflow and control flow, insert necessary buffers and layout transforms, generate test data and optimize for hardware use, latency, and throughput.

Implementations may use templates for common operations. Templates may be implemented using assembly language, RAIL, or similar. RAIL is comparable to assembly language in that memory units and compute units are separately programmed, but it can provide a higher level of abstraction and compiler intelligence via a concise performance-oriented domain-specific language for CGR array templates. RAIL enables template writers and external power users to control interactions between logical compute units and memory units with high-level expressions without the need to manually program capacity splitting, register allocation, etc. The logical compute units and memory units also enable stage/register allocation, context splitting, transpose slotting, resource virtualization and mapping to multiple physical compute units and memory units (e.g., PCUs and PMUs).

Template library 1124 may include an assembler that provides an architecture-independent low-level programming interface as well as optimization and code generation for the target hardware. Responsibilities of the assembler may include address expression compilation, intra-unit resource allocation and management, making a template graph physically realizable with target-specific rules, low-level architecture-specific transformations and optimizations, and architecture-specific code generation.

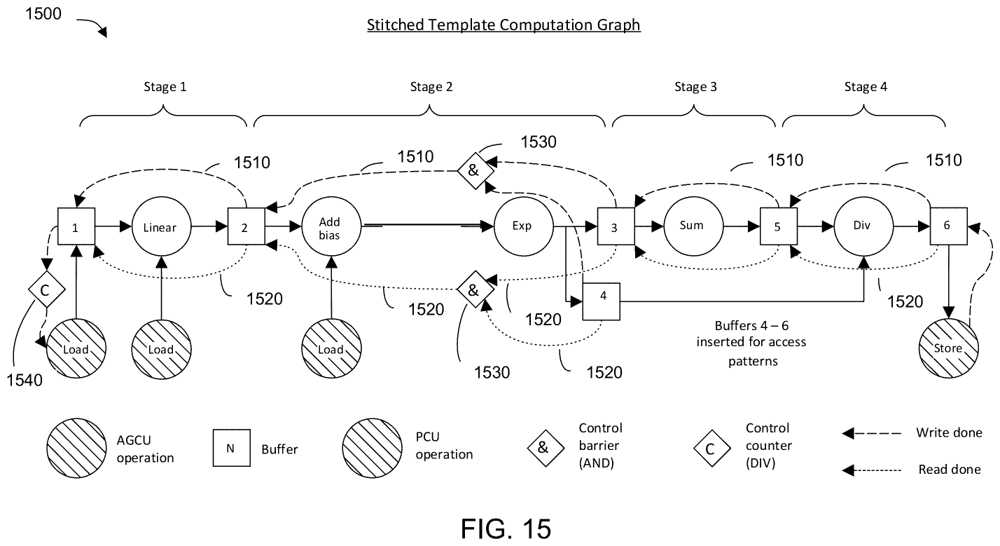

FIG. 15 shows the user program 1200 in an example fourth stage of the compiler stack. The template graph compiler 1123 may also determine the control signals 1510 and 1520, as well as control gates 1530 and 1540 required to enable the CGR units (whether logical or physical) to coordinate dataflow between the CGR units in the CGR array of a SRDAP. This process, sometimes referred to as stitching, produces a stitched template compute graph 1500 with control signals 1510-1520 and control gates 1530-1540. In the example depicted in FIG. 15, the control signals include write done signals 1510 and read done signals 1520, and the control gates include ‘AND’ gates 1530 and a counting or ‘DIV’ gate 1540. The control signals and control gates enable coordinated dataflow between the configurable units of SRDAPs such as compute units, memory units, and AGCUs.

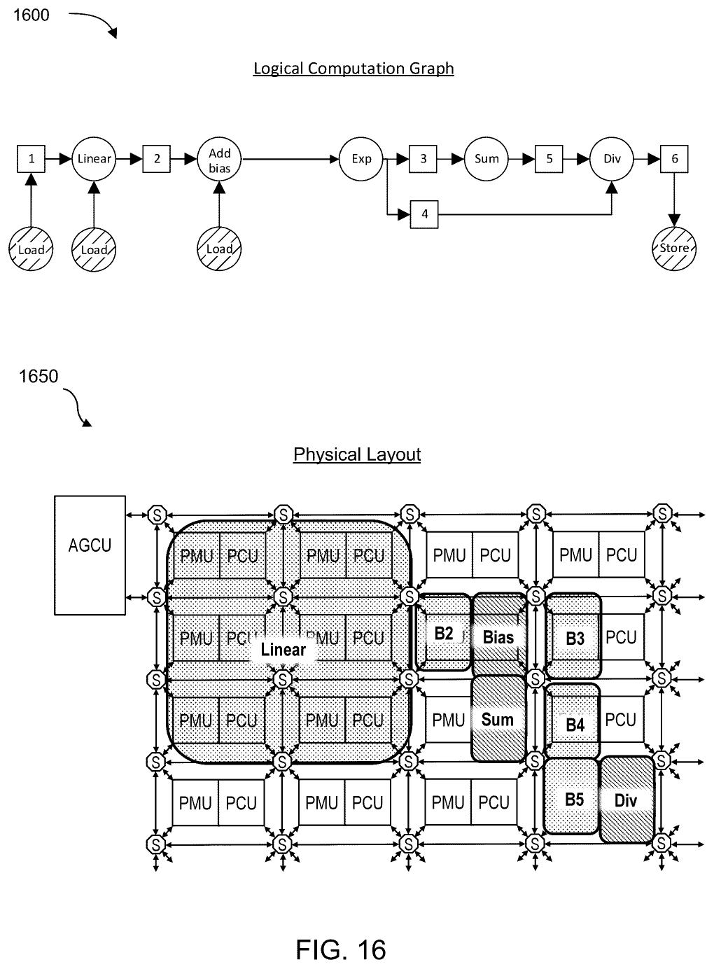

PNR 1125 translates and maps logical (i.e., unplaced physically realizable) CGR units (e.g., the nodes of the logical computation graph 1600 shown in FIG. 16) to a physical layout (e.g., the physical layout 1650 shown in FIG. 16) on the physical level, e.g., a physical array of CGR units in a semiconductor chip. PNR1125 also determines physical data channels to enable communication among the CGR units and between the CGR units and circuits coupled via the TLN; allocates ports on the CGR units and switches; provides configuration data and initialization data for the target hardware; and produces configuration files, e.g., processor-executable format (PEF) files. It may further provide bandwidth calculations, allocate network interfaces such as AGCUs and virtual address generators (VAGs), provide configuration data that allows AGCUs and/or VAGs to perform address translation, and control ALN switches and data routing. PNR 1125 may provide its functionality in multiple steps and may include multiple modules (not shown in FIG. 11) to provide the multiple steps, e.g., a placer, a router, a port allocator, and a PEF file generator. PNR 1125 may receive its input data in various ways. For example, it may receive parts of its input data from any of the earlier modules (dataflow graph compiler 1121, algebraic graph compiler 1122, template graph compiler 1123, and/or template library 1124). In some implementations, an earlier module, such as template graph compiler 1123, may have the task of preparing all information for PNR 1125 and no other units provide PNR input data directly.

Further implementations of compiler 1120 provide for an iterative process, for example by feeding information from PNR 1125 back to an earlier module, so that the earlier module can execute a new compilation step in which it uses physically realized results rather than estimates of or placeholders for physically realizable circuits. For example, PNR 1125 may feed information regarding the physically realized circuits back to algebraic graph compiler 1122.

Memory allocations represent the creation of logical memory spaces in on-chip and/or off-chip memories for data required to implement the dataflow graph, and these memory allocations are specified in the configuration file. Memory allocations define the type and the number of hardware circuits (functional units, storage, or connectivity components). Main memory (e.g., DRAM) may be off-chip memory, and scratchpad memory (e.g., SRAM) is on-chip memory inside a CGR array. Other memory types for which the memory allocations can be made for various access patterns and layouts include cache, read-only look-up tables (LUTs), serial memories (e.g., FIFOs), and register files.

Compiler 1120 binds memory allocations to unplaced memory units and binds operations specified by operation nodes in the dataflow graph to unplaced compute units, and these bindings may be specified in the configuration data. In some implementations, compiler 1120 partitions parts of a dataflow graph into memory and compute subgraphs and specifies these subgraphs in the PEF file. A memory subgraph may comprise address calculations leading up to a memory access. A compute subgraph may comprise all other operations in the parent graph. In one implementation, a parent graph is broken up into multiple memory subgraphs and exactly one compute subgraph. A single parent graph can produce one or more memory subgraphs, depending on how many memory accesses exist in the original loop body. In cases where the same memory addressing logic is shared across multiple memory accesses, address calculation may be duplicated to create multiple memory subgraphs from the same parent graph.

Compiler 1120 generates the configuration files with configuration data (e.g., a bit stream) for the placed positions and the routed data and control networks. In one implementation, this includes assigning coordinates and communication resources of the physical CGR units by placing and routing unplaced units onto the array of CGR units while maximizing bandwidth and minimizing latency.

FIG. 16 shows the logical computation graph 1600 and an example physical layout 1650 of the user program.

A first example of accelerated deep learning is using a deep learning accelerator implemented in a CGRA to train a neural network. A second example of accelerated deep learning is using the deep learning accelerator to operate a trained neural network to perform inferences. A third example of accelerated deep learning is using the deep learning accelerator to train a neural network and subsequently perform inference with any one or more of the trained neural network, information from the trained neural network, and a variant of the same.

Examples of neural networks include fully connected neural networks (FCNNs), multilayer perceptron networks (MLP) recurrent neural networks (RNNs), graph neural networks (GNNs), convolutional neural networks (CNNs), graph convolutional networks (GCNs), long short-term memory (LSTM) networks, transformers, autoencoders, deep belief networks, and generative adversarial networks (GANs).

An example of training a neural network is determining one or more weights associated with the neural network, such as by back-propagation in a deep learning accelerator. An example of making an inference is using a trained neural network to compute results by processing input data using the weights associated with the trained neural network. As used herein, the term ‘weight’ is an example of a ‘parameter’ as used in various forms of neural network processing. For example, some neural network learning is directed to determining parameters (e.g., through back-propagation) that are usable for performing neural network inferences.

A neural network processes data according to a dataflow graph comprising layers of neurons. Example layers of neurons include input layers, hidden layers, and output layers. Stimuli (e.g., input data) are received by an input layer of neurons and the computed results of the dataflow graph (e.g., output data) are provided by an output layer of neurons. Example hidden layers include rectified linear unit (ReLU) layers, fully connected layers, recurrent layers, graphical network layers, long short-term memory layers, convolutional layers, kernel layers, dropout layers, and pooling layers. A neural network may be conditionally and/or selectively trained. After being trained, a neural network may be conditionally and/or selectively used for inference.

Examples of ICs, or parts of ICs, that may be used as deep learning accelerators, are processors such as central processing unit (CPUs), SRDAP ICs, graphics processing units (GPUs), FPGAS, ASICs, application-specific instruction-set processor (ASIP), and digital signal processors (DSPs). The disclosed technology implements efficient distributed computing by allowing an array of accelerators (e.g., reconfigurable processors) attached to separate hosts to directly communicate with each other via buffers.

Some examples are listed below:

Example 1. A computer-implemented method of reusing a static compilation of a computation graph on a statically reconfigurable dataflow architecture processor (SRDAP), the method comprising: receiving a first request to generate a first instantiation of the computation graph to generate a first probability distribution for N classes, wherein N is a positive integer; retrieving a compiled graph of the computation graph from a computer memory, the computation graph including a bias node and a probability distribution node for M classes, wherein M is a positive integer greater than N and the bias node provides a biased tensor of size M to the probability distribution node by adding a bias tensor to a calculated tensor; generating a first bias tensor having N entries equal to zero and M−N entries having negative values; loading the compiled graph with the first bias tensor as the bias tensor for the bias node into a first set coarse-grained reconfigurable (CGR) units of the SRDAP as the first instantiation of the computation graph; executing the first instantiation of the computation graph on the SRDAP to generate the first probability distribution, wherein the first probability distribution comprises N entries of a first output of the probability distribution node of the first instantiation of the computation graph corresponding to the N entries equal to zero in the first bias tensor; and providing a first inference based on the first probability distribution.

Example 2. The computer-implemented method of example 1, the probability distribution node comprising a SoftMax function.

Example 3. The computer-implemented method of example 1, wherein the M−N negative entries of the first bias tensor each have an absolute value that is at least one order of magnitude greater than N.

Example 4. The computer-implemented method of example 1, wherein the first bias tensor comprises M entries equal to zero followed by M−N entries equal to a predetermined negative number.

Example 5. The computer-implemented method of example 4, wherein the predetermined negative number is equal to a minimum negative value representable by a data type used for the first bias tensor.

Example 6. The computer-implemented method of example 1, further comprising loading a set of weights for the computation graph into the SRDAP with the compiled graph.

Example 7. The computer-implemented method of example 6, wherein the set of weights for the computation graph includes pretrain weights determined by pre-training the computation graph.

Example 8. The computer-implemented method of example 7, further comprising performing finetune training of the first instantiation of the computation graph and updating the set of weights for the computation graph based on the finetune training.

Example 9. The computer-implemented method of example 6, wherein the set of weights for the computation graph includes weights determined by pre-training and then finetune training the computation graph.

Example 10. The computer-implemented method of example 1, wherein the compiled graph has a first subset of the first set of CGR units of the SRDAP assigned to the bias node and a second subset of the first set of CGR units of the SRDAP assigned to the probability distribution node.

Example 11. The computer-implemented method of example 1, the computation graph represents a classification neural network.

Example 12. The computer-implemented method of example 11, the classification neural network comprises a transformer neural network, a long short term memory neural network, a recurrent neural network, and/or a multilayer perceptron neural network with one or more hidden layers.

Example 13. The computer-implemented method of example 1, further comprising: receiving a second request to generate a second instantiation of the computation graph to generate a second probability distribution for R classes, wherein R is a positive integer different than N and less than M; generating a second bias tensor having R entries equal to zero and by M−R entries having negative values; retrieving the compiled graph; loading the compiled graph with the second bias tensor as the bias tensor for the bias node into a second set of CGR units of the SRDAP as the second instantiation of the computation graph; executing the second instantiation of the computation graph on the SRDAP to generate the second probability distribution, wherein second probability distribution comprises R entries of a second output of the probability distribution node of the second instantiation of the computation graph corresponding to the R entries equal to zero in the second bias tensor; and providing a second inference based on the second probability distribution.

Example 14. The computer-implemented method of example 1, further comprising: obtaining the computation graph; compiling the computation graph to generate the compiled graph; and saving the compiled graph.

Example 15. The computer-implemented method of example 1, further comprising: obtaining an initial computation graph including a classification neural network providing M logits; inserting the bias node between the classification neural network and the probability distribution node to create the computation graph; compiling the computation graph to generate the compiled graph; and saving the compiled graph.

Example 16. One or more non-transitory computer-readable storage media in which computer program instructions are stored, the computer program instructions operative to cause one or more processors, in response to being executed by the one or more processors, to: receive a first request to generate a first instantiation of a computation graph to generate a first probability distribution for N classes, wherein N is a positive integer; retrieve a compiled graph of the computation graph from a computer memory, the computation graph including a bias node and a probability distribution node for M classes, wherein M is a positive integer greater than N and the bias node provides a biased tensor of size M to the probability distribution node by adding a bias tensor to a calculated tensor; generate a first bias tensor having N entries equal to zero and M−N entries having negative values; load the compiled graph with the first bias tensor as the bias tensor for the bias node into a first set coarse-grained reconfigurable (CGR) units of a statically reconfigurable dataflow processor (SRDAP) as the first instantiation of the computation graph; initiate execution of the first instantiation of the computation graph on the SRDAP to generate the first probability distribution, wherein the first probability distribution comprises N entries of a first output of the probability distribution node of the first instantiation of the computation graph corresponding to the N entries equal to zero in the first bias tensor; and provide a first inference based on the first probability distribution.

Example 17. The one or more non-transitory computer-readable storage media of example 16, wherein the probability distribution node comprises a SoftMax function.

Example 18. The one or more non-transitory computer-readable storage media of example 16, wherein the M−N negative entries of the first bias tensor each have an absolute value that is at least one order of magnitude greater than N.

Example 19. The one or more non-transitory computer-readable storage media of example 16, wherein the first bias tensor comprises M entries equal to zero followed by M−N entries equal to a predetermined negative number.

Example 20. The one or more non-transitory computer-readable storage media of example 19, wherein the predetermined negative number is equal to a minimum negative value representable by a data type used for the first bias tensor.

Example 21. The one or more non-transitory computer-readable storage media of example 16, the computer program instructions further operative to cause the one or more processors, in response to being executed by the one or more processors, to load a set of weights for the computation graph into the SRDAP with the compiled graph.

Example 22. The one or more non-transitory computer-readable storage media of example 21, wherein the set of weights for the computation graph includes pretrain weights determined by pre-training the computation graph.

Example 23. The one or more non-transitory computer-readable storage media of example 22, the computer program instructions further operative to cause the one or more processors, in response to being executed by the one or more processors, to perform finetune training of the first instantiation of the computation graph and update the set of weights for the computation graph based on the finetune training.

Example 24. The one or more non-transitory computer-readable storage media of example 22, wherein the set of weights for the computation graph includes weights determined by pre-training and then finetune training the computation graph.

Example 25. The one or more non-transitory computer-readable storage media of example 16, wherein the compiled graph has a first subset of the first set of CGR units of the SRDAP assigned to the bias node and a second subset of the first set of CGR units of the SRDAP assigned to the probability distribution node.

Example 26. The one or more non-transitory computer-readable storage media of example 16, wherein the computation graph represents a classification neural network.

Example 27. The one or more non-transitory computer-readable storage media of example 26, wherein the classification neural network comprises a transformer neural network, a long short term memory neural network, a recurrent neural network, and/or a multilayer perceptron neural network with one or more hidden layers.

Example 28. The one or more non-transitory computer-readable storage media of example 16, the computer program instructions further operative to cause the one or more processors, in response to being executed by the one or more processors, to: receive a second request to generate a second instantiation of the computation graph to generate a second probability distribution for R classes, wherein R is a positive integer different than N and less than M; generate a second bias tensor having R entries equal to zero and by M−R entries having negative values; retrieve the compiled graph; load the compiled graph with the second bias tensor as the bias tensor for the bias node into a second set of CGR units of the SRDAP as the second instantiation of the computation graph; initiate execution of the second instantiation of the computation graph on the SRDAP to generate the second probability distribution, wherein second probability distribution comprises R entries of a second output of the probability distribution node of the second instantiation of the computation graph corresponding to the R entries equal to zero in the second bias tensor; and provide a second inference based on the second probability distribution.

Example 29. The one or more non-transitory computer-readable storage media of example 16, the computer program instructions further operative to cause the one or more processors, in response to being executed by the one or more processors, to: obtain the computation graph; compile the computation graph to generate the compiled graph; and save the compiled graph.

Example 30. The one or more non-transitory computer-readable storage media of example 16, the computer program instructions further operative to cause the one or more processors, in response to being executed by the one or more processors, to: obtain an initial computation graph including a classification neural network providing M logits; insert the bias node between the classification neural network and the probability distribution node to create the computation graph; compile the computation graph to generate the compiled graph; and save the compiled graph.

Example 31. A system including one or more processors and a statically reconfigurable dataflow processor (SRDAP) coupled to the one or more processors, the one or more processors programmed to: receive a first request to generate a first instantiation of a computation graph to generate a first probability distribution for N classes, wherein N is a positive integer; retrieve a compiled graph of the computation graph from a computer memory, the computation graph including a bias node and a probability distribution node for M classes, wherein M is a positive integer greater than N and the bias node provides a biased tensor of size M to the probability distribution node by adding a bias tensor to a calculated tensor; generate a first bias tensor having N entries equal to zero and M−N entries having negative values; load the compiled graph with the first bias tensor as the bias tensor for the bias node into a first set coarse-grained reconfigurable (CGR) units of the SRDAP as the first instantiation of the computation graph; initiate execution of the first instantiation of the computation graph on the SRDAP to generate the first probability distribution, wherein the first probability distribution comprises N entries of a first output of the probability distribution node of the first instantiation of the computation graph corresponding to the N entries equal to zero in the first bias tensor; and provide a first inference based on the first probability distribution.

Example 32. The system of example 31, wherein the probability distribution node comprises a SoftMax function.

Example 33. The system of example 31, wherein the M−N negative entries of the first bias tensor each have an absolute value that is at least one order of magnitude greater than N.

Example 34. The system of example 31, wherein the first bias tensor comprises M entries equal to zero followed by M−N entries equal to a predetermined negative number.

Example 35. The system of example 34, wherein the predetermined negative number is equal to a minimum negative value representable by a data type used for the first bias tensor.

Example 36. The system of example 31, the one or more processors further programmed to load a set of weights for the computation graph into the SRDAP with the compiled graph.

Example 37. The system of example 36, wherein the set of weights for the computation graph includes pretrain weights determined by pre-training the computation graph.

Example 38. The system of example 37, the one or more processors further programmed to perform finetune training of the first instantiation of the computation graph and update the set of weights for the computation graph based on the finetune training.

Example 39. The system of example 37, wherein the set of weights for the computation graph includes weights determined by pre-training and then finetune training the computation graph.

Example 40. The system of example 31, wherein the compiled graph has a first subset of the first set of CGR units of the SRDAP assigned to the bias node and a second subset of the first set of CGR units of the SRDAP assigned to the probability distribution node.

Example 41. The system of example 31, wherein the computation graph represents a classification neural network.

Example 42. The system of example 41, wherein the classification neural network comprises a transformer neural network, a long short term memory neural network, a recurrent neural network, and/or a multilayer perceptron neural network with one or more hidden layers.

Example 43. The system of example 31, the one or more processors further programmed to: receive a second request to generate a second instantiation of the computation graph to generate a second probability distribution for R classes, wherein R is a positive integer different than N and less than M; generate a second bias tensor having R entries equal to zero and by M−R entries having negative values; retrieve the compiled graph; load the compiled graph with the second bias tensor as the bias tensor for the bias node into a second set of CGR units of the SRDAP as the second instantiation of the computation graph; initiate execution of the second instantiation of the computation graph on the SRDAP to generate the second probability distribution, wherein second probability distribution comprises R entries of a second output of the probability distribution node of the second instantiation of the computation graph corresponding to the R entries equal to zero in the second bias tensor; and provide a second inference based on the second probability distribution.

Example 44 The system of example 31, the one or more processors further programmed to: obtain the computation graph; compile the computation graph to generate the compiled graph; and save the compiled graph.

Example 45. The system of example 31, the one or more processors further programmed to: obtain an initial computation graph including a classification neural network providing M logits; insert the bias node between the classification neural network and the probability distribution node to create the computation graph; compile the computation graph to generate the compiled graph; and save the compiled graph.

### Further or Additional Considerations

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections-these recitations are hereby incorporated forward by reference into each of the implementations described herein.

Although the description has been described with respect to particular implementations thereof, these particular implementations are merely illustrative, and not restrictive. The description may reference specific structural implementations and methods, and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to particular implementations thereof, these particular implementations are merely illustrative, and not restrictive. For instance, many of the operations can be implemented in a CGRA system, a System-on-Chip (SoC), application-specific integrated circuit (ASIC), programmable processor, in a programmable logic device such as a field-programmable gate array (FPGA) or a graphics processing unit (GPU), obviating a need for at least part of the dedicated hardware. Implementations may be as a single chip, or as a multi-chip module (MCM) packaging multiple semiconductor dies in a single package. All such variations and modifications are to be considered within the ambit of the present disclosed technology the nature of which is to be determined from the foregoing description.

One or more implementations of the technology or elements thereof can be implemented in the form of a computer product, including a non-transitory computer-readable storage medium with computer usable program code for performing any indicated method steps and/or any configuration file for one or more SRDAPs to execute a high-level program. Furthermore, one or more implementations of the technology or elements thereof can be implemented in the form of an apparatus including a memory and at least one processor that is coupled to the memory and operative to perform exemplary method steps, and/or a SRDAP that is operative to execute a high-level program based on a configuration file. Yet further, in another aspect, one or more implementations of the technology or elements thereof can be implemented in the form of means for carrying out one or more of the method steps described herein and/or executing a high-level program described herein. Such means can include (i) hardware module(s); (ii) software module(s) executing on one or more hardware processors; (iii) bit files for configuration of a CGR array; or (iv) a combination of aforementioned items.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit of the technology disclosed.

What is claimed is:

1. A computer-implemented method of reusing a static compilation of a computation graph on a statically reconfigurable dataflow architecture processor (SRDAP), the method comprising:
receiving a first request to generate a first instantiation of the computation graph to generate a first probability distribution for N classes, wherein N is a positive integer;
retrieving a compiled graph of the computation graph from a computer memory, the computation graph including a bias node and a probability distribution node for M classes, wherein M is a positive integer greater than N and the bias node provides a biased tensor of size M to the probability distribution node by adding a bias tensor to a calculated tensor;
generating a first bias tensor having N entries equal to zero and M−N entries having negative values;
loading the compiled graph with the first bias tensor as the bias tensor for the bias node into a first set coarse-grained reconfigurable (CGR) units of the SRDAP as the first instantiation of the computation graph;
executing the first instantiation of the computation graph on the SRDAP to generate the first probability distribution, wherein the first probability distribution comprises N entries of a first output of the probability distribution node of the first instantiation of the computation graph corresponding to the N entries equal to zero in the first bias tensor; and
providing a first inference based on the first probability distribution.

2. The computer-implemented method of claim 1, the probability distribution node comprising a SoftMax function.

3. The computer-implemented method of claim 1, wherein the M−N negative entries of the first bias tensor each have an absolute value that is at least one order of magnitude greater than N.

4. The computer-implemented method of claim 1, wherein the first bias tensor comprises M entries equal to zero followed by M−N entries equal to a predetermined negative number.

5. The computer-implemented method of claim 4, wherein the predetermined negative number is equal to a minimum negative value representable by a data type used for the first bias tensor.

6. The computer-implemented method of claim 1, further comprising loading a set of weights for the computation graph into the SRDAP with the compiled graph.

7. The computer-implemented method of claim 6, wherein the set of weights for the computation graph includes pretrain weights determined by pre-training the computation graph.

8. The computer-implemented method of claim 7, further comprising performing finetune training of the first instantiation of the computation graph and updating the set of weights for the computation graph based on the finetune training.

9. The computer-implemented method of claim 6, wherein the set of weights for the computation graph includes weights determined by pre-training and then finetune training the computation graph.

10. The computer-implemented method of claim 1, wherein the compiled graph has a first subset of the first set of CGR units of the SRDAP assigned to the bias node and a second subset of the first set of CGR units of the SRDAP assigned to the probability distribution node.

11. The computer-implemented method of claim 1, the computation graph represents a classification neural network.

12. The computer-implemented method of claim 1, further comprising:
receiving a second request to generate a second instantiation of the computation graph to generate a second probability distribution for R classes, wherein R is a positive integer different than N and less than M;
generating a second bias tensor having R entries equal to zero and by M−R entries having negative values;
retrieving the compiled graph;
loading the compiled graph with the second bias tensor as the bias tensor for the bias node into a second set of CGR units of the SRDAP as the second instantiation of the computation graph;
executing the second instantiation of the computation graph on the SRDAP to generate the second probability distribution, wherein second probability distribution comprises R entries of a second output of the probability distribution node of the second instantiation of the computation graph corresponding to the R entries equal to zero in the second bias tensor; and
providing a second inference based on the second probability distribution.

13. The computer-implemented method of claim 1, further comprising:
obtaining an initial computation graph including a classification neural network providing M logits;
inserting the bias node between the classification neural network and the probability distribution node to create the computation graph;
compiling the computation graph to generate the compiled graph; and
saving the compiled graph.

14. One or more non-transitory computer-readable storage media in which computer program instructions are stored, the computer program instructions operative to cause one or more processors, in response to being executed by the one or more processors, to:
receive a first request to generate a first instantiation of a computation graph to generate a first probability distribution for N classes, wherein N is a positive integer;
retrieve a compiled graph of the computation graph from a computer memory, the computation graph including a bias node and a probability distribution node for M classes, wherein M is a positive integer greater than N and the bias node provides a biased tensor of size M to the probability distribution node by adding a bias tensor to a calculated tensor;
generate a first bias tensor having N entries equal to zero and M−N entries having negative values;
load the compiled graph with the first bias tensor as the bias tensor for the bias node into a first set coarse-grained reconfigurable (CGR) units of a statically reconfigurable dataflow processor (SRDAP) as the first instantiation of the computation graph;
initiate execution of the first instantiation of the computation graph on the SRDAP to generate the first probability distribution, wherein the first probability distribution comprises N entries of a first output of the probability distribution node of the first instantiation of the computation graph corresponding to the N entries equal to zero in the first bias tensor; and
provide a first inference based on the first probability distribution.

15. The one or more non-transitory computer-readable storage media of claim 14, the computer program instructions further operative to cause the one or more processors, in response to being executed by the one or more processors, to load a set of weights for the computation graph into the SRDAP with the compiled graph.

16. The one or more non-transitory computer-readable storage media of claim 14, the computer program instructions further operative to cause the one or more processors, in response to being executed by the one or more processors, to:
obtain an initial computation graph including a classification neural network providing M logits;
insert the bias node between the classification neural network and the probability distribution node to create the computation graph;
compile the computation graph to generate the compiled graph; and
save the compiled graph.

17. A system including one or more processors and a statically reconfigurable dataflow processor (SRDAP) coupled to the one or more processors, the one or more processors programmed to:
receive a first request to generate a first instantiation of a computation graph to generate a first probability distribution for N classes, wherein N is a positive integer;
retrieve a compiled graph of the computation graph from a computer memory, the computation graph including a bias node and a probability distribution node for M classes, wherein M is a positive integer greater than N and the bias node provides a biased tensor of size M to the probability distribution node by adding a bias tensor to a calculated tensor;
generate a first bias tensor having N entries equal to zero and M−N entries having negative values;
load the compiled graph with the first bias tensor as the bias tensor for the bias node into a first set coarse-grained reconfigurable (CGR) units of the SRDAP as the first instantiation of the computation graph;
initiate execution of the first instantiation of the computation graph on the SRDAP to generate the first probability distribution, wherein the first probability distribution comprises N entries of a first output of the probability distribution node of the first instantiation of the computation graph corresponding to the N entries equal to zero in the first bias tensor; and
provide a first inference based on the first probability distribution.

18. The system of claim 17, the one or more processors further programmed to load a set of weights for the computation graph into the SRDAP with the compiled graph.

19. The system of claim 17, wherein the compiled graph has a first subset of the first set of CGR units of the SRDAP assigned to the bias node and a second subset of the first set of CGR units of the SRDAP assigned to the probability distribution node.

20. The system of claim 17, wherein the computation graph represents a classification neural network.
